(19) United States
(12) Patent Application Publication
(10) Pub. No.: US 2022/0368696 A1
(43) Pub. Date: Nov. 17, 2022

(54) PROCESSING MANAGEMENT FOR HIGH DATA I/O RATIO MODULES

(71) Applicant: Microsoft Technology Licensing, LLC, Redmond, WA (US)

(72) Inventors: Andrey KARPOVSKY, Kiryat Motzkin (IL); Roy LEVIN, Haifa (IL)

(21) Appl. No.: 17/321,549

(22) Filed: May 17, 2021

(51) Int. Cl. H04L 29/06

(52) U.S. Cl. CPC H04L 63/102; H04L 63/0236; H04L 63/1416; H04L 63/20

(57) ABSTRACT

Opaque module processing costs may be reduced without substantial loss of efficacy, e.g., security costs may be reduced with little or no loss of security. The processing cost of the opaque module is correlated with particular sets of input data, and the efficacy of the output resulting from processing samples of those sets is measured. Data whose processing is the most expensive or the most efficacious is identified. A data cluster is delimited by a parameter set, which may be supplied by a user or a machine learning model. Inputs to security tools may serve as parameters. The incremental cost and incremental efficacy of processing the cluster is determined. Security efficacy may be measured using alert counts, content, severity, and confidence. Processing cost and efficacy may then be managed by including or excluding particular datasets that match the parameters, either proactively pursuant to a policy, or per user selections.

### BACKGROUND

Noon In computing, an opaque module is one whose internal workings are not visible. An opaque module may also be referred to as a “closed module” or a “black box”. Even though the internal workings are hidden, sometimes aspects of the steps performed and the structures utilized inside an opaque module may be inferred by comparing the module's inputs with the module's outputs. But any conclusions about the internals of an opaque module should be open to revision.

As a very simple example, suppose that given the inputs 0, 1, 2, and 3, a particular opaque module M produces the respective outputs 1, 2, 3, and 4. Then a good working hypothesis is that M adds 1 to a given input and produces the resulting sum as the output. However, without either knowing what logic actually resides inside M, or else testing every one of an infinite number of possible inputs under an infinite number of possible circumstances, one cannot always be certain how M will behave. It is possible M's behavior is more complex. For instance, M may only add 1 to numbers that are less than 1000, or only add 1 to inputs received on a Wednesday, or M may start adding 2 to each input after the computer running M is rebooted, and so on.

In practice, many real-world computing systems include one or more opaque modules. Often the opaqueness is intentional, e.g., to avoid burdens on users, to discourage tinkering or tampering, and to simplify the creation of larger systems built by combining modules.

Accordingly, improvements in the management of opaque modules may provide technical advantages in many computing systems.

### SUMMARY

Some embodiments taught herein balance cybersecurity against security tools' processing costs, by identifying input data clusters whose incremental addition to security is far outweighed by their processing cost. Thus identified, the data cluster can be excluded from further processing without unduly degrading security. That is, the remaining data that is still processed continues to generate output that is efficacious so far as security is concerned.

Specific techniques for identifying such data clusters are described herein, including various ways to computationally delimit suitable data clusters, and various ways to computationally assess changes in security. Balances between processing costs and other kinds of data output efficacy are also described. Innovations described herein may be applied beneficially for balancing various processing costs against various measures of output data efficacy, even when the processing is performed by one or more opaque modules.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a data flow diagram illustrating aspects of a computing system configured with processing management enhancements taught herein;

FIG. 3 is a block diagram illustrating some aspects of some efficacy measures;

FIG. 4 is a block diagram illustrating some aspects of data clustering and data clustering parameter sets;

FIG. 5 is a block diagram illustrating some additional aspects of processing management;

FIG. 6 is a flowchart illustrating steps in some processing cost management methods; and

FIG. 7 is a flowchart further illustrating steps in some processing management methods.

### DETAILED DESCRIPTION

### Overview

Innovations may expand beyond their origins, but understanding an innovation's origins can help one more fully appreciate the innovation. In the present case, some teachings described herein were motivated by insights gained by innovators who were working to give customers better ways of understanding the cost-effectiveness of security controls. The benefits of cybersecurity are not always easily seen, but the processing costs for cybersecurity can be significant.

One of the technical challenges of determining an appropriate level of processing cost for cybersecurity efforts is therefore how to correlate processing done with security benefits obtained. An emergent technical challenge is how to distinguish between different processing options based, at least in part, on the security impact of each option.

Some embodiments herein address these technical challenges by identifying input data clusters which are relatively large and are defined by one or a few parameters. Cluster size may be defined, e.g., as a percentage of all input data to a given tool in a given time period, with a cutoff for “relatively large” being set at a value such as two percent of the input data, or at another user-defined value. Cluster defining parameters may be, e.g., values of the kind often fed into a SIEM or another security tool, e.g., IP addresses, user agents, source domains, or the like. Each relatively large cluster is then evaluated to assess the impact on the output data of processing the cluster as input data, or not processing it.

The impact of including or excluding a cluster from processing has at least two aspects: processing cost, and output efficacy. Impact is also referred to herein as “influence”. Processing cost may be in terms of processor cycles, memory consumed, network bandwidth, virtual machines created, or the like.

In the case of security processing, the efficacy represents quantifiable security. For instance, in one embodiment if excluding a cluster from processing by a security tool results in fewer malware alerts, then efficacy has decreased significantly because missing an apparent malware infection significantly reduces security. By contrast, the embodiment may be configured such that logins from unexpected locations generate alerts, but these are low priority because sales representatives often login from different locations over time. Accordingly, if excluding a cluster from processing results in fewer unexpected login location alerts, then in this embodiment the efficacy has not decreased significantly, and the processing cost for log or telemetry data like that in the cluster has been reduced or avoided.

Quantifying the influence of a given data cluster on processing cost and on the efficacy of the processing output correlates processing with efficacy on a per-cluster basis. Quantifying the respective influences of different input data clusters allows a system to automatically distinguish between different processing options (inclusion or exclusion of different clusters) based on the security (or other efficacy) impact of each option.

The foregoing examples and scenarios are not comprehensive. Other scenarios, technical challenges, and innovations will be apparent to one of skill upon reading the full disclosure herein.

Operating Environments

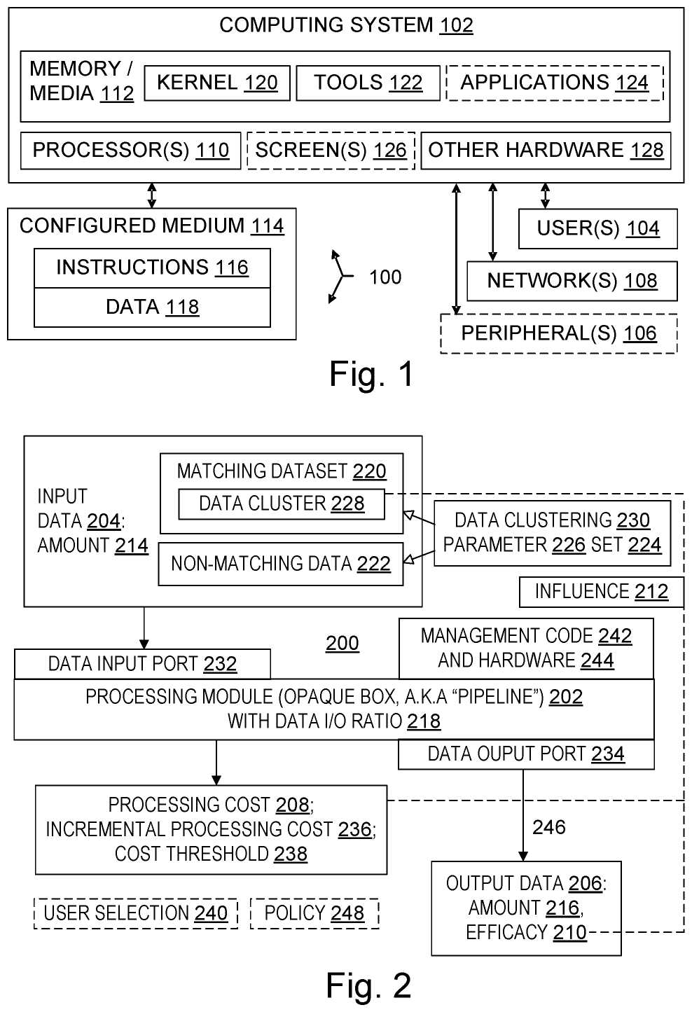

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112, also referred to as computer-readable storage devices 112. Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, functionality for processing management enhancements taught herein could be installed on an air gapped network such as a highly secure cloud or highly secure on-premises network, and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More About Systems

FIG. 2 illustrates a computing system 200 that has been enhanced according to processing management teachings provided herein; other Figures are also relevant to the system 200. A pipeline or other opaque processing module 202 receives input data 204, 118, does processing, and produces output data 206, 118. Many of the processing management teachings provided herein may be applied beneficially regardless of what specific processing is done in the module 202. Regardless of the specific internal workings of module 202, the module's processing has a cost 208, e.g., in terms of processor cycles, storage used, bandwidth used, etc. The module's processing also has an efficacy 210. The efficacy 210 of a security module 202, for example, could be measured in terms of number 304 of alerts 302 produced as output data 206, the content 306 of the alerts produced, or the severity 308 of the alerts produced. Other kinds of efficacy 210 may be based on exceptions 314 raised, anomalies 324 or patterns 326 identified, or downtime 338, for instance.

Efficacy 210 is a characteristic of output data 206 in a given context. Efficacy may be used to measure how good the output is, e.g., whether the security module output includes security alerts the security personnel want it to include. Choices about what input data 204 is processed may be based on the influence 212 of particular input data 204 on the efficacy 210 of the resulting output data 206. Influence 212 is a characteristic of input data 204, which may be used to measure how including or excluding particular data 118 as input 204 to the module 202 changes the efficacy 210 of the output and how the inclusion or exclusion changes the processing cost 208 of producing the output 206.

Although teachings herein may be applied to manage processing done by a wide variety of modules, a particular subset of modules 202 is of greater interest herein. These are modules 202 which have a large amount 214 of input data compared to the amount 216 of output data. The ratio of input data size 214 to output data size 216 for a given module 202 is referred to herein as the “data I/O ratio” 218 of the module.

Security modules 202 often have a data I/O ratio of one hundred or more. That is, they often take in at least a hundred times as much data as they emit in the form of alerts 302. Data which is simply passed through by a security module, e.g., replicated or forwarded, is not counted among the output when calculating the data I/O ratio. Likewise, data that is not central to the efficacy of the output, such as telemetry back to the security tool's developer to support bug fixes, is not counted among the output when calculating the data I/O ratio.

An intrusion detection system, SIEM, or other security tool often receives large amounts 214 of data such as full traffic logs, security logs, event logs, or sniffed packets, as input 204. Most of this input corresponds to routine authorized activity. But on occasion, malware, suspect activity or some particular anomalous event 324 is detected, and therefore an alert 302 is emitted as output 206. Accordingly, in a cloud or enterprise environment 100 the input 204 could include millions (or more) data points per hour, while the output 206 is at most a few hundred. In systems 200 that have one or more modules 202 whose data I/O ratio is one hundred or higher, teachings herein may be particularly beneficial for reducing processing cost 208 without much (or any) adverse impact on efficacy.

As shown in FIG. 2, the module's input data 204 may be divided into matching data 220 and non-matching data 222, based on a parameter set 224. For example, “one or more private IP addresses” could be a parameter 226, or user agent could be a parameter 226, etc. A data cluster 228 is part or all of the matching data 220. The cluster might be only part of the data that matches under the parameter set, due to more matching data coming in over time, or due to sampling, or both, for example. The data cluster 228 is used to calculate an influence value 212. For clarity of illustration, FIG. 2 only shows one data cluster 228. But a given embodiment may have multiple data clusters. For example, if the parameter set 224 defines IP address ranges, there could be one data cluster per IP address range.

In operation, some embodiments form a data cluster 228, calculate the influence 212 of the data cluster on the efficacy 210 and the processing cost 208, and then manage exposure of the matching dataset 220 to the processing module 202. The matching dataset 220 includes the cluster 228 and other data 118 which are like it in that they also match the specified parameter set 224. This processing management may include, e.g., reporting the influence 212 to a user 104, or marking the matching data 220 for inclusion 708 because it has too much influence 212 to exclude despite its processing cost 208, or excluding 710 the matching data 220 from processing by the module 202 because the loss 348 of efficacy 210 from excluding it is considered acceptable in view of the reduction 236 in processing cost 208.

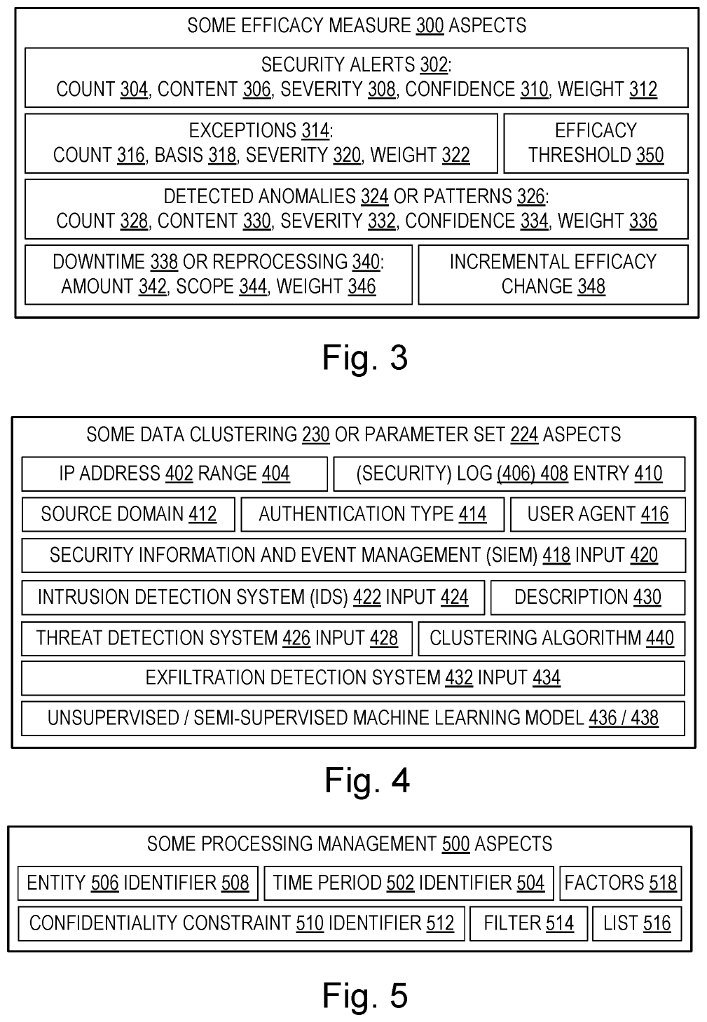

FIG. 3 shows some examples or aspects of some efficacy measures 300. This is not meant to be a comprehensive list. These items and other items relevant to influence 212 measurement generally, including some efficacy metrics 300, are discussed at various points herein, and additional details regarding them are provided in the discussion of a List of Reference Numerals later in this disclosure document.

FIG. 4 shows some examples or aspects of data clustering 230. This is not meant to be a comprehensive list. These items and other items relevant to data clustering are discussed at various points herein, and additional details regarding them are provided in the discussion of a List of Reference Numerals later in this disclosure document.

FIG. 5 shows some additional aspects of processing management 500, which includes management of processing cost 208, management of processing output efficacy 210, or both, depending on the embodiment and the particular settings, configuration, and other circumstances of the embodiment's operation. This is not meant to be a comprehensive list. These items and other items relevant to processing management are discussed at various points herein, and additional details regarding them are provided in the discussion of a List of Reference Numerals later in this disclosure document.

Some embodiments use or provide a functionality-enhanced system, such as system 200 or another system 102 that is enhanced as taught herein. In some embodiments, an enhanced processing cost management system which is configured for processing cost 208 management of a processing module 202 includes a digital memory 112 and a processor 110 in operable communication with the memory. The processing module 202 is configured to receive an input data amount 214 of input data 204 at a data input port 232 and to produce an output data amount 216 of output data 206 at a data output port 234. In this example, the processing module is further characterized in that over a specified time period 502 the input data amount is at least 100 times the output data amount.

This enhanced computing system is configured to perform processing cost management 600 steps. These steps include (a) forming 602 a data cluster 228 from a part of the input data 204, the data cluster delimited 702 according to a data clustering parameter set 224, (b) calculating 604 an influence value 212 for the data cluster with regard to an efficacy measure 300 of processing module output data 206, and (c) managing 606 exposure 608 of a matching dataset 220 to the processing module data input port 232 based on the influence value and on a processing cost 208.

The matching dataset 220 is also delimited 702 according to the data clustering parameter set 224. For instance, the parameter set 224 could delimit a cluster 228 containing emails which have no attachment and which came from inside contoso dot corn during the past thirty minutes. After calculating 604 that processing this cluster accounted for about 17% of the processing by the module 202 of all input data 204 for that time period but only 2% of alerts 302 overall and zero high severity 308 alerts 302, the system 200 could proceed by excluding 710 all matching data 220 going forward, namely, not processing any emails 118 that have no attachment and came from inside contoso dot com.

This exclusion from module 202 processing could be in response to a user command 240 after the influence 212 numbers are displayed 716 to an admin 104. Or the exclusion could be proactive, based on influence thresholds. For instance, the system could determine automatically and proactively that the 17% incremental processing cost 236 is above a cost threshold 238 of 5%, determine that the incremental efficacy loss 348 is below an efficacy threshold 350 of 3%, and determine that the incremental efficacy loss does not include any apparent loss of high severity alerts 302. In response to these computational determinations, the system 200 could determine proactively exclude 710 all the matching data 220. This system also notifies 716 the admin of the exclusion, and will accept an override 240 from the admin to reduce or remove the exclusion.

In some embodiments, the efficacy measure 300 is based on at least one of the following: a count 304 of security alerts 302 produced as output data 206, a content 306 of one or more security alerts 302 that are produced as output data 206, a severity 308 of one or more security alerts 302 that are produced as output data 206, or a confidence 310 in one or more security alerts 302 that are produced as output data 206.

For example, when a count 304 of alerts 302 is used to measure efficacy 210, producing fewer alerts 302 is treated as an efficacy loss. When the content 306 of alerts 302 is used to measure efficacy 210, alerts are effectively sorted by the kind of content they contain, e.g., an alert that states malware was detected has more efficacy 210 than an alert stating that an account has not been used in the past thirty days. When the severity 308 of alerts 302 is used to measure efficacy 210, alerts are effectively sorted by their assigned severity level, e.g., an alert from locking out an elevated privilege account due to consecutive failed login attempts is more severe and hence more efficacious than an alert from locking out a normal non-admin account due to consecutive failed login attempts. Security alert content 306 and alert severity 308 may be related, e.g., a malware-detected alert may have high severity, but alerts with different content may also have the same severity as each other. When the confidence 310 assigned to alerts 302 (e.g., by a machine learning model that generates alerts) is used to measure efficacy 210, alerts with higher confidence have more efficacy 210 than alerts with lower assigned confidence.

In some embodiments, the data clustering parameter set 224 delimits the cluster 228 based on at least one of the following parameters 226: an IP address 402, a security log 406 entry, a user agent 416, an authentication type 414, a source domain 412, an input 420 to a security information and event management tool 418, an input 424 to an intrusion detection system 422, an input 428 to a threat detection tool 426, or an input 434 to an exfiltration detection tool 432.

Unless otherwise expressly stated, for the purpose of claim scope the system 200 does not include the processing module 202 per se. However, the module 202 may be enhanced to not merely process data 204 but also run code 242 that performs processing cost management as taught herein, or to be at least partially controlled by such code 242, to form the system 200.

Some embodiments include the processing module 202 in combination with hardware 244, 110, 112 running processing cost management code 242. In some of these, over a specified time period 502 the input data amount is at least 500 times the output data amount. In some, the data I/O ratio is at least 800, in some it is at least 1000, in some it is at least 1500, and in some it is at least 2000.

Some embodiments include a machine learning model 436 or 438 or both, which is configured to form 602 the data cluster 228 according to the data clustering parameter set 224. Clustering algorithms 440 such as K-means, DBSCAN, centroid, density, hierarchical agglomerative, or neural net, may be used alone or in combination to perform data clustering 230.

As noted, many teachings provided herein may be applied regardless of any particular characteristics of the processing module 202 whose cost 208 and efficacy 210 are being managed 700. However, one collection of modules 202 which are of particular interest is modules that have relatively high data I/O ratios 218, e.g., ratios of one hundred or higher. It is expected that the benefits of applying teachings herein will tend to be significant with regard to such modules.

Another collection of modules 202 of particular interest is modules that are not mere filters 514. For present purposes, a filter 514 is a module 202 whose processing merely removes some of the input 204 and sends the rest through as the output 206. Many modules that do some filtering also do other processing, so there are opportunities with them to benefit from selective exclusion 710. By contrast, a module that behaves only as a filter 514 is less promising. A filter 514 may have a high data I/O ratio 218 if it passes only a fraction (e.g., 1% or less) of the input 204 through as output 206. But the data fed to a filter 514 tends to be uniform so far as influence 212 is concerned. So clustering 230 may well either put all input data into a single cluster, or not reveal different clusters with different respective influences relative to cluster size. Accordingly, in some embodiments the processing module 202 is not a mere filter 514, because the module 202 is characterized in that the module's output data 206 includes data 118 that is not present in the module's input data 204.

Other system embodiments are also described herein, either directly or derivable as system versions of described processes or configured media, duly informed by the extensive discussion herein of computing hardware.

Although specific module 202 and processing examples are discussed and shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different security controls, processing modules, data clustering algorithms, data cluster parameters, time periods, technical features, mechanisms, operational sequences, data structures, or other functionalities for instance, and may otherwise depart from the examples provided herein.

Processes (a.k.a. Methods)

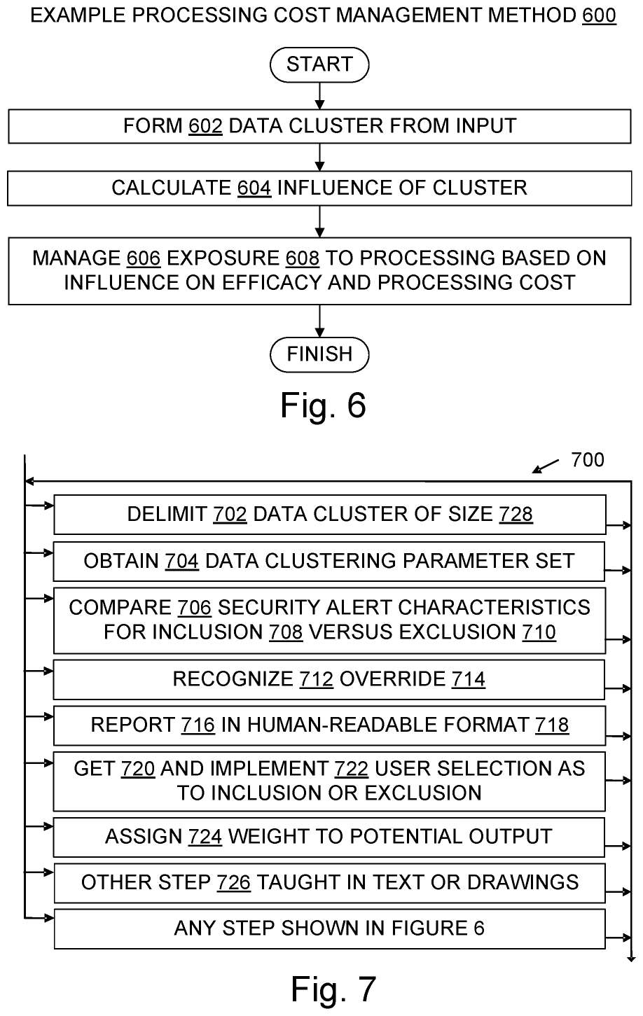

FIGS. 6 and 7 illustrate process families 600, 700 that may be performed or assisted by an enhanced system, such as system 200 or another processing cost management functionality enhanced system as taught herein. Such processes may also be referred to as “methods” in the legal sense of that word.

Technical processes shown in the Figures or otherwise disclosed will be performed automatically, e.g., by an enhanced processing module 202, unless otherwise indicated. Some related processes may also be performed in part automatically and in part manually to the extent action by a human person is implicated, e.g., a human user 104 may designate a reported 716 matching dataset 220 for inclusion 708 or exclusion 710, but no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 6 and 7. Steps may be performed serially, in a partially overlapping manner, or fully in parallel. In particular, the order in which action items of FIGS. 6 and 7 are traversed to indicate the steps performed during a process may vary from one performance of the process to another performance of the process. Steps may also be omitted, combined, renamed, regrouped, be performed on one or more machines, or otherwise depart from the illustrated flow, provided that the process performed is operable and conforms to at least one claim.

Some embodiments use or provide a method for managing processing cost of a processing module, the method including the following automatic steps: forming 602 a data cluster 228 from a part of input data 204 to a processing module 202, the data cluster delimited 702 according to a data clustering parameter set 224, the processing module configured to produce 246 output data based on the input data, the processing module characterized in that over a specified time period 502 an input data amount 214 is at least 1000 times an output data amount 216 (i.e., data I/O ratio 218 is at least 1000); calculating 604 an influence value 212 for the data cluster with regard to an efficacy measure 300 of at least a portion of the output data 206; and managing 606 exposure 608 of a matching dataset 220 to the processing module 202 based on the influence value and on a processing cost 208 or 236 that is associated with the processing module processing of at least a portion of the matching dataset, wherein the matching dataset 220 is delimited 702 according to the data clustering parameter set.

In some embodiments, the method includes automatically obtaining 704 the data clustering parameter set from an unsupervised machine learning model 436. For instance, an embodiment may use machine-learning for feature extraction, and then use the features 226 for clustering.

In some embodiments, particular definitions of influence are utilized for security models 202. In some, the influence of data (either a single data point or a set) is its relative effect on the output of the model. For example, suppose the output of a threat detection model is one hundred generated alerts of equal severity. If removal 710 of data changes the status of four alerts (by adding them to the output 206 or removing them from the output 206), then the influence on efficacy is 4/100=0.04. In case the removal affects thirty alerts, the influence is 30/100=0.3.

In some embodiments, calculating the influence value 212 includes at least one of the following: comparing 706 a count 304 of security alerts 302 in output data 206 that is produced 246 by the processing module 202 from input data 204 that includes 708 the data cluster 228 to a count 304 of security alerts 302 in output data 206 that is produced 246 by the processing module 202 from input data 204 that excludes 710 the data cluster 228; comparing 706 a content 306 of one or more security alerts 302 in output data 206 that is produced 246 by the processing module 202 from input data 204 that includes 708 the data cluster 228 to a content 306 of one or more security alerts 302 in output data 206 that is produced 246 by the processing module 202 from input data 204 that excludes 710 the data cluster 228; comparing 706 a severity 308 of one or more security alerts 302 in output data 206 that is produced 246 by the processing module 202 from input data 204 that includes 708 the data cluster 228 to a severity 308 of one or more security alerts 302 in output data 206 that is produced 246 by the processing module 202 from input data 204 that excludes 710 the data cluster 228; or comparing 706 a confidence 310 in one or more security alerts 302 in output data 206 that is produced 246 by the processing module 202 from input data 204 that includes 708 the data cluster 228 to a confidence 310 in one or more security alerts 302 in output data 206 that is produced 246 by the processing module 202 from input data 204 that excludes 710 the data cluster 228.

In some embodiments, managing 606 exposure 608 of the matching dataset 220 to the processing module 202 includes at least one of the following: excluding 710 at least a portion of the matching dataset from data input to the processing module when an incremental processing cost 236 of processing the matching dataset is above a specified cost threshold 238 and an incremental efficacy gain 348 of processing the matching dataset is below a specified efficacy threshold 350 (informally, cost exceeds efficacy); or in response to an override condition 240, including 708 at least a portion of the matching dataset in data input to the processing module when an incremental processing cost 236 of processing the matching dataset is above a specified cost threshold 238 and an incremental efficacy gain 348 of processing the matching dataset is below a specified efficacy threshold 350 (informally, cost exceeds efficacy, but the override says process it anyway; the override could be via a user command, or a policy, for example).

Different embodiments or configurations or both may implement different cost versus efficacy tradeoffs for different customers, or different times, or different kinds of data. In some embodiments, managing 606 exposure of the matching dataset to the processing module is based on the influence value, the processing cost, and at least one of the following: an entity identifier 508 identifying an entity 506 which provides the input data 204; an entity identifier 508 identifying an entity 506 which receives the output data 206; a time period identifier 504 identifying a time period 502 in which the input data 204 is submitted 608 to the processing module 202; a time period identifier 504 identifying a time period 502 in which the output data 206 is produced 246 by the processing module 202; a confidentiality identifier 512 indicating a confidentiality constraint 510 on the input data 204; or a confidentiality identifier 512 indicating a confidentiality constraint 510 on the output data 206.

For example, different cloud customers 506 could have different thresholds 350, 238. As another example, a data cluster 228 containing data 118 labeled as medical information, or as financial information, could face different thresholds 350, 238 than data that lacks such labels. As yet another example, a data cluster 228 containing data 118 received during the work week could face different thresholds 350, 238 than data received during a weekend.

In some embodiments, managing 606 exposure of the matching dataset to the processing includes reporting 716 at least one of the following in a human-readable format 718: a description 430 of the data clustering parameter set, an incremental processing cost 236 of processing the data cluster, and an incremental efficacy change 348 of not processing the data cluster; or an ordered list 516 of potential candidate datasets 228 or 220 for exclusion 710 from processing, with the list ordered on a basis which includes candidate dataset influence 212 on processing cost 208 or on efficacy 210 or on both.

In some embodiments, the management method 700 includes automatically obtaining 704 the data clustering parameter set 224 using a semi-supervised machine learning model 438. An admin may suggest particular parameters 226 be included, or may choose between features 226 generated by machine learning. The input signals to a machine learning model include data 220 intermixed with data 222, and the outputs include candidate parameters 226 and their respective cluster 228 sizes 728.

Some embodiments use offline processing to calculate the influence. In some, the processing module 202 is operable during an online period 502 or during an offline period 502, and calculating 604 the influence value 212 for the data cluster 228 is performed during the offline period. Thus, influence calculation need not hamper normal online processing.

In some embodiments, managing 606 exposure of the matching dataset to the processing includes: reporting 716 in a human-readable format (e.g., on screen in a table with natural language headers) an incremental processing cost 236 of processing the data cluster, and an incremental efficacy change 348 of not processing the data cluster; getting 720 a user selection 240 specifying whether to include 708 the data cluster as input data to the processing module; and then implementing 722 the user selection, e.g., by the inclusion 708 or the exclusion 710 of a matching dataset 220 in accordance with the user selection 240.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as processing cost management code 242, influence variables 212 and associated code, cost threshold variables 238 and associated code, efficacy measure variables 300 and associated code, efficacy threshold variables 350 and associated code, or software fully or partially implementing flows shown in FIG. 6 or 7, in the form of data 118 and instructions 116, read from a removable storage medium 114 and/or another source such as a network connection, to form a configured storage medium. The configured storage medium 112 is capable of causing a computer system 102 to perform technical process steps for processing cost management utilizing influence 212 in a computing system, as disclosed herein. The Figures thus help illustrate configured storage media embodiments and process (a.k.a. method) embodiments, as well as system and process embodiments. In particular, any of the process steps illustrated in FIG. 6 or 7, or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a cloud or other computing system to perform a method for managing processing cost 208, 236 of a processing module 202. This process includes: forming 602 a data cluster from a part of input data 204 to a processing module, the data cluster delimited 702 according to a data clustering parameter set, the processing module configured to produce 246 output data 206 based on the input data, with the output data including data that is not present in the input data, the processing module characterized in that over a specified time period an input data amount is at least 3000 times an output data amount; calculating 604 an influence value 212 for the data cluster with regard to an efficacy measure 300 of at least a portion of the output data; and managing 606 exposure of a matching dataset to the processing module based on the influence value and a processing cost 208 or 236 that is associated with the processing module processing at least a portion of the matching dataset, the matching dataset delimited 702 according to the data clustering parameter set.

In some embodiments, security alerts 302 or other output 206 get weighted differently 724 than one another when calculating 604 influence. In some, the efficacy measure 300 is based on security alerts 302 in the output data, and the method 700 includes assigning 724 different weights 312 to at least two respective security alerts when calculating the influence value. In some of these, different weights 312 are assigned 724 based on at least one of the following: a security alert content 306, a security alert severity 308, or a security alert confidence 310.

In some embodiments, the processing cost 208 (and hence the incremental processing cost 236) represents at least one of the following cost factors 518: a number of processor cycles, an elapsed processing time, an amount of memory, an amount of network bandwidth, a number of database transactions, or an amount of electric power.

In some embodiments, the processing module is characterized in that over a specified time period 502 of at least one hour an input data amount 214 is at least 10000 times an output data amount 206. That is, for the hour in question the module 202 data I/O ratio is at least 10000.

### ADDITIONAL EXAMPLES AND OBSERVATIONS

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, some additional examples and observations are offered in the following sections.

Some embodiments implement a data influence model for lowering data processing costs 208 in security features 202. Data security is important, and failure to follow the correct protocols can potentially come at a tremendous price in the event of an exploit. On the other hand, the day-to-day cost of security operations can be high as well. This can lead to a decision to save costs by disabling security features, which may well leave digital resources at risk.

A major contributor to these processing costs in some environments is the ensemble of costs associated with input data 204 for various security features, e.g., costs of ingestion (CPU, network bandwidth), storage (memory), and processing (CPU) to check for anomalies or patterns of suspicious activity. For example, in the case of cloud security services such as threat detection, recommendations for investigating activity, exfiltration detection, intrusion detection, and so forth, the input data often contains some or all of the data 118 stored in various logs 408 that are used as input for the security services. These input data 204 are used inside the security module 202 to compute the output 206, e.g., detection alerts, recommendations, and so on.

Some embodiments offer a way to save on these costs 208 without compromising security, or at least provide insight into the particular security reduction that is likely to result from a particular cost reduction. This allows an informed decision to be made by an administrator, and allows proactive automated decision-making pursuant to a policy 248.

An embodiment may calculate the value of different subsets of data to the security feature by looking at the subset's influence on the output. In this way, if a subset of data is large enough but has low influence, it can be excluded from the data processing pipeline, thus saving cost 208 without significantly decreasing the effectiveness of the security feature.

Some embodiments utilize a normalized and meaningful metric for influence, which can be used by a resource owner in order to balance the amount and value of ingested data based on the owner's needs. For example, for more sensitive resources (e.g., financial data and users' personal data) or during more vulnerable times (e.g., very busy shopping days), more data 204 can be ingested, thus increasing costs but also maximizing security. For less important resources, or less intense time periods, costs can be saved while having an insubstantial or at least controlled decrease in security. In many embodiments, a definition and implementation of the metric is agnostic as to the module's internals. Moreover, access to configure or modify the module 202 internal logic or output format is not necessary for advantageous use of the teachings provided herein.

Some embodiments automatically search for subsets 228, 220 of data 204 that are significant in size or processing cost (two pieces of data of the same size may have different processing costs), are easily and transparently defined, and have negligible influence on the outcome 210 of the security model or other module 202 processing. This may involve looking for big or expensive clusters 228 of data 204 that are easily defined by a small list of meaningful parameters 226. For example, in case of data 204 describing telemetry logs 408 of a cloud service, an embodiment may look for sets of data sharing source IP ranges 404, user agents 416, types of authentication 414, and so on. This can be achieved by using 230 various clustering algorithms 440, for example hierarchical clustering.

For each defined cluster 228 of data the embodiment calculates 604 the cluster's influence, e.g., the change in number and content of alerts from exclusion or inclusion of the cluster as input 204. When this influence is negligible (below a predefined very low threshold), the embodiment can suggest that the admin authorize discarding the data 220 defined by the same parameters 226 as this cluster in the future, thus saving a known percentage of processing costs 208 without significantly decreasing the customer's security stance.

There may be some departure in practice from this estimated savings. But it is expected that the predicted cost savings based on the data cluster 228 will be sufficiently close to the actual cost savings based on the full matching data 220 defined by the same parameters to make the embodiments useful.

In some embodiments, one may reasonably expect to decrease costs for input data of a security service without changing the effectiveness of the service itself. For example, an embodiment may offer 716 an option to save 20% of costs 208 by excluding 710 certain kinds of logs or by excluding 710 logs from a certain app, while decreasing security feature effectiveness only by 0.2%. Because the underlying rationale and data flow of the management 606 model is transparent, normalized, and meaningful, it can be flexibly used by a customer to balance cost versus security considerations, e.g., based on secured resource type.

Additional support for the discussion above is provided below. For convenience, this additional support material appears under various headings. Nonetheless, it is all intended to be understood as an integrated and integral part of the present disclosure's discussion of the contemplated embodiments.

Technical Character

The technical character of embodiments described herein will be apparent to one of ordinary skill in the art, and will also be apparent in several ways to a wide range of attentive readers. Some embodiments address technical activities such as determining processing costs 208, 236, measuring output efficacy 210, calculating 604 an influence 212 fora data cluster 228, obtaining 704 parameters from a machine learning model 436 or 438, and including 708 or excluding 710 particular available data 220 or 222 as inputs 204 for processing by computer system module 202, which are each an activity deeply rooted in computing technology. Some of the technical mechanisms discussed include, e.g., management code 242, efficacy metrics 300, thresholds 238 and 350, security modules 418, 422, 426, 432, and machine learning models 436 and 438. Some of the technical effects discussed include, e.g., reductions in processing 208 with controlled small or no corresponding loss of efficacy 210, disclosure of data clusters 228 whose processing is more expensive than other similarly sized data clusters 228, and data processing cost reduction flexibility based on data-related characteristics such as entity 506, time period 502, or confidentiality 510. Thus, purely mental processes and activities limited to pen-and-paper are clearly excluded. Other advantages based on the technical characteristics of the teachings will also be apparent to one of skill from the description provided.

Some embodiments described herein may be viewed by some people in a broader context. For instance, concepts such as efficiency, privacy, productivity, reliability, speed, or trust may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to reduce cybersecurity costs without unintentionally or rashly reducing security in practice. Other configured storage media, systems, and processes involving efficiency, privacy, productivity, reliability, speed, or trust are outside the present scope. Accordingly, vagueness, mere abstractness, lack of technical character, and accompanying proof problems are also avoided under a proper understanding of the present disclosure.

### Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples and scenarios, flows, savings amounts, types of processing cost, measures of processing output value, time period examples, software processes, security tools, identifiers, data structures, data selections, naming conventions, notations, groupings, or other implementation choices described herein. Any apparent conflict with any other patent disclosure, even from the owner of the present innovations, has no role in interpreting the claims presented in this patent disclosure.

### ACRONYMS, ABBREVIATIONS, NAMES, AND SYMBOLS

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GPU: graphical processing unit

GUI: graphical user interface

HTTP(S): hypertext transfer protocol (secure)

IaaS or IAAS: infrastructure-as-a-service

ID: identification or identity

IoT: Internet of Things

IP: internet protocol

LAN: local area network

OS: operating system

PaaS or PAAS: platform-as-a-service

RAM: random access memory

ROM: read only memory

TCP: transmission control protocol

TLS: transport layer security

TPU: tensor processing unit

UDP: user datagram protocol

UEFI: Unified Extensible Firmware Interface

URI: uniform resource identifier

URL: uniform resource locator

WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

An “administrator” (or “admin”) is any user that has legitimate access (directly or indirectly) to multiple accounts of other users by using their own account's credentials. Some examples of administrators include network administrators, system administrators, domain administrators, privileged users, service provider personnel, and security infrastructure administrators.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“IoT” or “Internet of Things” means any networked collection of addressable embedded computing or data generation or actuator nodes. Such nodes may be examples of computer systems as defined herein, and may include or be referred to as a “smart” device, “endpoint”, “chip”, “label”, or “tag”, for example, and IoT may be referred to as a “cyber-physical system”. IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage— RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

“Secured” means only that some security is provided, not that the effectiveness of the security is guaranteed.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Processing cost management operations such as clustering 602 data 118, calculating 604 a data influence value 212, obtaining 704 a data clustering parameter 226, communicating with a machine learning model 436 or 438, and many others taught herein, are understood to be inherently digital. A human mind cannot interface directly with a CPU or other processor, or with RAM or other digital storage, to read and write the necessary data to perform the processing management steps 700 taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as assigning, calculating, clustering, comparing, delimiting, detecting, determining, forming, getting, implementing, influencing, managing, obtaining, processing, recognizing, reporting, (and assigns, assigned, calculates, calculated, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment
102 computer system, also referred to as a “computational system” or “computing system”, and when in a network may be referred to as a “node”
104 users, e.g., user of an enhanced system 200
106 peripherals
108 network generally, including, e.g., LANs, WANs, software-defined networks, clouds, and other wired or wireless networks
110 processor
112 computer-readable storage medium, e.g., RAM, hard disks; also referred to broadly as “memory”, which may be volatile or nonvolatile, or a mix
114 removable configured computer-readable storage medium
116 instructions executable with processor; may be on removable storage media or in other memory (volatile or nonvolatile or both)
118 data
120 kernel(s), e.g., operating system(s), BIOS, UEFI, device drivers
122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, and so on
124 applications, e.g., word processors, web browsers, spreadsheets, games, email tools, commands
126 display screens, also referred to as “displays”
128 computing hardware not otherwise associated with a reference number 106, 108, 110,
200 computing system 102 enhanced with processing management functionality taught herein, e.g., with one or more of a management code 242, functionality according to FIG. 6 or 7, or any other functionality first taught herein
202 processing module; a computing system 102 or portion thereof which receives input data 204 and produces output data 206
204 input data; digital
206 output data; digital
208 processing cost; represented digitally
210 efficacy of output 206; may also be viewed as efficacy of the module 202 as evident in the output 206
212 influence value representing influence of particular input data on efficacy 210 or on cost 208 or on both; unless stated otherwise, influence on both is presumed; the influence of data (either a single data point or a set) may be viewed as its relative effect on the output of the module 202
214 amount of input data, e.g., in megabytes
216 amount of output data, e.g., in megabytes
218 data I/O ratio of a module, defined as the amount of input to a module divided by the amount of output produced by the module during the time period in which that input was ingested by the module
220 matching dataset, also referred to as “matching data”; data that is delimited by (i.e., matches) a particular parameter set 224
222 non-matching data; available input data that does not match a given parameter set 224; data is matching or non-matching with regard to a parameter set—particular data may be matching with regard to one parameter set and non-matching with regard to a different parameter set
224 set of one or more parameters 226
226 parameter which partially or entirely defines (i.e., bounds or delimits) a set of matching data
228 cluster of digital data, as defined by a parameter set for some time period (alternately, the time period may be considered one of the parameters 226)
230 data clustering, e.g., computational action of grouping or delimiting data based on a parameter set
232 data input port to module 202, e.g., API, endpoint, data buffer, port in a networking sense, or other computational mechanism into which input data is exposed for ingestion by the module 202
234 data output port from module 202, e.g., API, endpoint, data buffer, port in a networking sense, or other computational mechanism from which output data is emitted or otherwise produced 246 by the module 202
236 increment of processing cost 208 that is associated with particular data; may be positive (more cost) or negative (less cost) or zero (no change in cost); digital
238 processing cost threshold; digital
240 user selection or command or override, e.g., a command to include particular data among the input data, or a command to exclude particular data from input data; represented digitally and implemented computationally
242 processing management code, e.g., software code that utilizes efficacy threshold 350 or cost threshold 238 as taught herein, software code that calculates an influence 212, software code that performs method 600, software code that performs any method 700, or other software code that reports on and either balances or supports balancing processing cost against efficacy using matching data 220 as taught herein
244 hardware which supports execution of processing management code 242, e.g., processor 110, memory 112, network or other communication interface, screen 126 for reporting 716, keyboard or other input device for receiving selections 240
246 computational activity by module 202 of producing output 206, e.g., emitting the output at the output port 234, and the supporting computational activity inside module 202 that generated the output in response to the input 204
248 policy, e.g., thresholds, conditions for inclusion 708 or exclusion 710; digital data structure
300 efficacy measure; computational artifact, e.g., software code that measures efficacy 210 in at least one manner taught herein, or a digital value representing an efficacy level or category or amount that is a result of executing such efficacy measurement code; also referred to as an “efficacy metric”
302 security alert; digital
304 number of security alert(s)
306 content of security alert
308 severity of security alert
310 confidence level or value of security alert
312 weight assigned 724 to security alert
314 exception; digital; generally indicates an unusual or unwanted (or both) event occurred during module 202 processing
316 number of exception(s)
318 basis of exception, e.g., bad pointer, out of memory, etc.
320 severity of exception
322 weight assigned 724 to exception
324 anomaly; determined computationally
326 pattern; determined computationally
328 number of anomalies or number of patterns
330 content of anomaly or content of pattern or description thereof
332 severity of anomaly or severity of pattern
334 confidence level or value of anomaly or of pattern
336 weight assigned 724 to anomaly or to pattern
338 processing downtime of module 202
340 reprocessing by module 202 of input previously processed, due to corruption or loss or unavailability of output from prior processing
342 amount of downtime (e.g., duration) or amount of reprocessing (e.g., input size, or cost)
344 scope of downtime (e.g., which kinds of data, which modules) or scope of reprocessing (e.g., which inputs, or which outputs are being reproduced)
346 weight assigned 724 to downtime or to reprocessing
348 increment of efficacy 210 that is associated with particular data; may be positive (more efficacy) or negative (less efficacy) or zero (no change in efficacy); digital
350 efficacy threshold; digital
402 IP address; digital
404 IP address range; digital
406 security log; digital
408 log generally; digital
410 entry in a log; digital
412 source domain of an email, login attempt, or other digital item
414 authentication type; digital; e.g., cryptographic protocol used, whether multifactor authentication was used, etc.
416 user agent; digital
418 security information and even management tool 122; also referred to as SIEM
420 any data or parameter used in a given environment as input to a SIEM
422 intrusion detection system (IDS); a tool 122
424 any data or parameter used in a given environment as input to an IDS
426 threat detection system (TDS); a tool 122
428 any data or parameter used in a given environment as input to a TDS
430 digital description in human-readable format
432 exfiltration detection system (EDS); a tool 122
434 any data or parameter used in a given environment as input to an EDS
436 unsupervised machine learning model; computational
438 supervised machine learning model; computational
440 clustering algorithm, or software code implementing a clustering 230 algorithm
500 processing management aspect, e.g., activity or tool; processing management is a generalization of processing cost management; processing management includes processing cost management and also includes processing efficacy management; processing management methods are also referred to by reference number 700
502 time period; digital data structure
504 pointer, index, or other identifier of time period 502
506 entity, as represented digitally
508 name, pointer, index, or other identifier of entity 506
510 confidentiality level or other constraint, as represented digitally
512 label, level, or other identifier of confidentiality 510
514 filter module 202
516 list of datasets; digital data structure
518 cost factors, as represented digitally
600 flowchart; 600 also refers to processing cost management methods illustrated by or consistent with the FIG. 6 flowchart
602 computationally form a data cluster of actual or potential input data
604 computationally calculate an influence 212 of data with respect to a module 202
606 computationally manage (e.g., include 709, exclude 710, report 716) submission 608 of particular data as input to a module 202
608 submission of data as input to a module 202; also referred to as “exposure” of the data to the module for processing by the module
700 flowchart; 700 also refers to processing management methods illustrated by or consistent with the FIG. 7 flowchart (which incorporates the steps of FIG. 6)
702 computationally define a data cluster; also referred to as delimiting or bounding the data cluster; may be done by specifying a parameter set
704 computationally obtain a parameter set, e.g., from a user or from a machine learning model
706 computationally compare values while calculating efficacy
708 computationally include data among input data
710 computationally exclude data from input data
712 computationally recognize a user's override of proactive or policy inclusion 708 or exclusion 710, e.g., by implementing 722 the override or by warning the user that the override violates policy 248, or both
714 user's override of proactive or policy inclusion 708 or exclusion 710; computational; a particular kind of user selection 240
716 computationally report information, e.g., by displaying on screen placing in email or text message or log
718 human-readable format, e.g., on screen or on paper, as opposed to binary format in memory 112
720 computationally get a user selection 240, e.g., through a software user interface
722 computationally implement a user selection 240, e.g., by including 708 data, marking data for inclusion 708, excluding 710 data, marking data for exclusion; marking data need not actually change the data, as it may be done by setting a value in a data structure that represents the data and actions to be taken (or not taken) with the data
724 computationally assign a weight (312, 322, 336, 346, or other weight) to certain output 206 for efficacy calculation purposes
726 any step discussed in the present disclosure that has not been assigned some other reference numeral
728 data cluster size, e.g., in megabytes

### CONCLUSION

In short, the teachings herein provide a variety of processing management functionalities which operate in enhanced systems 200. Opaque module 202 processing costs 208 may be reduced without substantial loss of efficacy 210, e.g., security costs 208 may be reduced with little or no loss of security 210. The processing cost 208 of the opaque module 202 is correlated piecewise with particular sets 220 of input data 204 for at least one set 220, and the efficacy 210 of the output 206 resulting 246 from processing samples 228 of those sets 220 is measured 300. Data 118 whose processing 246 is the most expensive or the most efficacious is thus identified. A data cluster 228 is delimited 702 by a parameter set 224, which may be supplied 704 by a user 104 or by a machine learning model 436 or 438. Inputs (e.g., 420, 424, 428, 434) to security tools 122 may serve as parameters 226. The incremental cost 236 and incremental efficacy 348 of processing 246 the cluster 228 is determined 604. Security efficacy 210 may be measured 300 using alert counts 304, content 306, severity 308, and confidence 310, with corresponding weights 312. Other efficacies 210 may be measured 300 similarly, e.g., in terms of processing exceptions 314, anomalies 324, patterns 326, downtime 338, or reprocessing 340. Processing cost 208 and efficacy 210 may then be managed 606 by including 708 or excluding 710 particular datasets 220 that match the parameters 226, either proactively pursuant to a policy 248, or per user selections 240.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 6 and 7 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A processing cost management system configured for processing cost management of a processing module, the processing module having a data input port and a data output port, the processing module configured to receive an input data amount of input data at the data input port and to produce an output data amount of output data at the data output port, the processing module characterized in that over a specified time period the input data amount is at least 100 times the output data amount, the processing cost management system comprising:
a digital memory; and
a processor in operable communication with the digital memory, the processor configured to perform processing cost management steps including (a) forming a data cluster from a part of the input data, the data cluster delimited according to a data clustering parameter set, (b) calculating an influence value for the data cluster with regard to an efficacy measure of processing module output data, and (c) managing exposure of a matching dataset to the processing module data input port based on the influence value and a processing cost, the matching dataset delimited according to the data clustering parameter set.

2. The system of claim 1, wherein the efficacy measure is based on at least one of the following: a count of security alerts produced as output data, a content of one or more security alerts that are produced as output data, a severity of one or more security alerts that are produced as output data, or a confidence in one or more security alerts that are produced as output data.

3. The system of claim 1, wherein the data clustering parameter set delimits the cluster based on at least one of the following: an IP address, a security log entry, a user agent, an authentication type, a source domain, an input to a security information and event management tool, an input to an intrusion detection system, an input to a threat detection tool, or an input to an exfiltration detection tool.

4. The system of claim 1, in combination with the processing module, and wherein over the specified time period the input data amount is at least 500 times the output data amount.

5. The system of claim 1, comprising a machine learning model which is configured to form the data cluster according to the data clustering parameter set.

6. The system of claim 1, wherein the processing module is further characterized in that the output data includes data that is not present in the input data.

7. A method for managing processing cost of a processing module, comprising:
forming a data cluster from a part of input data to a processing module, the data cluster delimited according to a data clustering parameter set, the processing module configured to produce output data based on the input data, the processing module characterized in that over a specified time period an input data amount is at least 1000 times an output data amount;
calculating an influence value for the data cluster with regard to an efficacy measure of at least a portion of the output data; and
managing exposure of a matching dataset to the processing module based on the influence value and a processing cost associated with the processing module processing at least a portion of the matching dataset, the matching dataset delimited according to the data clustering parameter set.

8. The method of claim 7, further comprising automatically obtaining the data clustering parameter set from an unsupervised machine learning model.

9. The method of claim 7, wherein calculating the influence value includes at least one of the following:
comparing a count of security alerts in output data that is produced by the processing module from input data that includes the data cluster to a count of security alerts in output data that is produced by the processing module from input data that excludes the data cluster;
comparing a content of one or more security alerts in output data that is produced by the processing module from input data that includes the data cluster to a content of one or more security alerts in output data that is produced by the processing module from input data that excludes the data cluster;
comparing a severity of one or more security alerts in output data that is produced by the processing module from input data that includes the data cluster to a severity of one or more security alerts in output data that is produced by the processing module from input data that excludes the data cluster; or
comparing a confidence in one or more security alerts in output data that is produced by the processing module from input data that includes the data cluster to a confidence in one or more security alerts in output data that is produced by the processing module from input data that excludes the data cluster.

10. The method of claim 7, wherein managing exposure of the matching dataset to the processing module includes at least one of the following:
excluding at least a portion of the matching dataset from data input to the processing module when an incremental processing cost of processing the matching dataset is above a specified cost threshold and an incremental efficacy gain of processing the matching dataset is below a specified efficacy threshold; or
in response to an override condition, including at least a portion of the matching dataset in data input to the processing module when an incremental processing cost of processing the matching dataset is above a specified cost threshold and an incremental efficacy gain of processing the matching dataset is below a specified efficacy threshold.

11. The method of claim 7, wherein managing exposure of the matching dataset to the processing module is based on the influence value, the processing cost, and at least one of the following:
an entity identifier identifying an entity which provides the input data;
an entity identifier identifying an entity which receives the output data;
a time period identifier identifying a time period in which the input data is submitted to the processing module;
a time period identifier identifying a time period in which the output data is produced by the processing module;
a confidentiality identifier indicating a confidentiality constraint on the input data; or
a confidentiality identifier indicating a confidentiality constraint on the output data.

12. The method of claim 7, wherein managing exposure of the matching dataset to the processing comprises reporting at least one of the following in a human-readable format:
a description of the data clustering parameter set, an incremental processing cost of processing the data cluster, and an incremental efficacy change of not processing the data cluster; or
an ordered list of potential candidate datasets for exclusion from processing, the list ordered on a basis which includes candidate dataset influence on processing cost or efficacy or both.

13. The method of claim 7, further comprising automatically obtaining the data clustering parameter set using a semi-supervised machine learning model.

14. The method of claim 7, wherein the processing module is operable during an online period or during an offline period, and calculating the influence value for the data cluster is performed during the offline period.

15. The method of claim 7, wherein managing exposure of the matching dataset to the processing comprises:
reporting in a human-readable format an incremental processing cost of processing the data cluster, and an incremental efficacy change of not processing the data cluster;
getting a user selection specifying whether to include the data cluster as input data to the processing module; and
implementing the user selection.

16. A computer-readable storage device configured with data and instructions which upon execution by a processor cause a computing system to perform a method for managing processing cost of a processing module, the method comprising:
forming a data cluster from a part of input data to a processing module, the data cluster delimited according to a data clustering parameter set, the processing module configured to produce output data based on the input data, with the output data including data that is not present in the input data, the processing module characterized in that over a specified time period an input data amount is at least 3000 times an output data amount;
calculating an influence value for the data cluster with regard to an efficacy measure of at least a portion of the output data; and
managing exposure of a matching dataset to the processing module based on the influence value and a processing cost associated with the processing module processing at least a portion of the matching dataset, the matching dataset delimited according to the data clustering parameter set.

17. The storage device of claim 16, wherein the efficacy measure is based on security alerts in the output data, and wherein the method comprises assigning different weights to at least two respective security alerts when calculating the influence value.

18. The storage device of claim 17, wherein different weights are assigned based on at least one of the following: a security alert content, a security alert severity, a security alert confidence.

19. The storage device of claim 17, wherein the processing cost represents at least one of the following: a number of processor cycles, an elapsed processing time, an amount of memory, an amount of network bandwidth, a number of database transactions, or an amount of electric power.

20. The storage device of claim 17, wherein the processing module is characterized in that over a specified time period of at least one hour an input data amount is at least 10000 times an output data amount.
